(19) United States
(12) Patent Application Publication
(10) Pub. No.: US 2006/0150255 A1
(43) Pub. Date: Jul. 6, 2006

(54) Manipulation-protected microcontroller system

(76) Inventor: Holger Ceskutti, Moeckmuehl (DE)

Correspondence Address: KENYON & KENYON LLP, ONE BROADWAY, NEW YORK, NY, 10004, US

(21) Appl. No.: 11/288,721

(22) Filed: Nov. 28, 2005

(30) Foreign Application Priority Data
Nov. 26, 2004 (DE) 10 2004 057 259.3

(51) Int. Cl. H04L 9/32

(52) U.S. Cl. 726/27

(57) ABSTRACT

A microcontroller system encompasses a processor unit, a source for confidential data, and a bus that connects the processor unit and source. Integrated on one single substrate together with the source is an access control unit that decides, on the basis of signals transferred on the bus, whether an output of confidential data from the source is permitted or blocked.

### FIELD OF THE INVENTION

The present invention relates to a microcontroller system having a processor unit, having a source for confidential data, and having an address and data bus that connects the processor unit and source.

### BACKGROUND INFORMATION

If, in the context of such a microcontroller system, an unauthorized intruder can manage to access the bus, the possibility exists that he may find out confidential data from the source (usually a memory module), modify the data, and replace the source or manipulate it so that it supplies the modified data instead of the original confidential data, in order to make the microcontroller system perform a function desired by him.

When a microcontroller system of this kind is used to control a machine such as, for example, the combustion engine of a motor vehicle, the danger exists that the operating reliability and/or service life of such a machine will be impaired.

Specifically in the case of engine control units for motor vehicles, unauthorized persons have a great interest in performing such manipulations, since they make it possible, for example, to increase the available power of the combustion engine. The consequence of such manipulations can be that the motor controlled in that fashion becomes damaged over the long term, that regulatory stipulations regarding the pollutant content of the engine's exhaust gases are no longer complied with, or that the vehicle reaches speeds for which its chassis is not designed and at which it is no longer safely controllable. There is therefore a considerable demand for techniques which make it impossible for unauthorized persons to manipulate the operating data of a microcontroller system such as, for example, an engine control unit, or which at least make any such manipulation so troublesome and labor-intensive that it is no longer of economic interest to an unauthorized person.

It is known, for example for operating data of such a microcontroller system that are stored in a permanent memory, e.g. for characteristic curves for controlling the engine, to calculate an integrity check value, i.e. a data value that changes with each change in an individual memory location of the operating data, and to store that value in the permanent memory together with the operating data. The result of any manipulation of the operating data is then, with high probability, that an integrity check value calculated by the processor unit at a system startup no longer agrees with the value stored in the permanent memory, so that the processor unit is capable of detecting the manipulation and refusing to operate. If, however, an unauthorized person knows the protocol according to which the integrity check value is calculated, he is in a position also to write into the permanent memory a modified integrity check value matching the manipulated operating data, so that the manipulation can no longer be detected.

Another possibility is to modify the very program used by the processor unit to perform the integrity check, in such a way that it is no longer capable of detecting a modification of the operating data. It is known that this can be made more difficult for an unauthorized person by storing the operating program, or at least substantial parts of it, in encoded form in a memory of the microcontroller system, and decoding it and storing it in a volatile memory only for immediate execution. Even this protection loses its effectiveness if the unauthorized person knows the encoding algorithm and, if applicable, a key used therefor. But because both must be stored permanently in the microprocessor system, an unauthorized person has available, in principle, an arbitrarily long time to look for the encoding algorithm and, if applicable, its key, and to attempt to crack the code.

### SUMMARY OF THE INVENTION

The present invention creates a microcontroller system that makes it considerably more difficult for an unauthorized person to access confidential data contained therein. For that purpose, an access control unit is integrated on a single substrate together with the source for the confidential data, and that unit is capable of blocking the output of data from the source and decides, on the basis of signals transferred on the bus, whether an output of confidential data from the source is permitted or blocked.

There are various approaches in terms of how the attack of an unauthorized person can be detected on the basis of signals transferred on the bus. One possibility is that the access control unit is set up to detect a program routine start address addressed by the processor unit, and to block output from the source if the start address lies outside a predefined permissible region. This region will generally be an address region whose contents can be considered comparatively well-secured against unauthorized manipulation, in particular the address region of a memory that is integrated with the processor unit on one common substrate. If the processor unit accesses an address in this region upon startup of a routine, e.g. upon booting or as a result of an interrupt, it can be assumed that an unmanipulated boot program is stored there, and that the microcontroller can therefore be allowed access to the confidential data, since it will make only the intended use of them. If, however, the processor unit starts up with an address outside the defined region, it must be assumed that a manipulated program is being used, and access to the confidential data is refused.

A definition of the permissible region should be stored permanently in the access control unit, whether by direct storage of the boundary addresses of that region or any kind of processing protocol which allows the access control to decide whether or not an address received via the address bus lies in the permissible region.

A particular danger of manipulation exists with microcontroller systems in which the processor unit is set up so as to take turns in control over the bus with at least one other unit, e.g. a coprocessor, a DMA controller, or the like. This other unit could also be a respective microprocessor that an unauthorized person connects to the microcontroller system in order to explore the latter's memory contents. In such a microcontroller system, however, a need generally exists for the processor unit and the other unit to communicate with one another in order to define which unit has control over the bus at which times, so that the access control unit can ascertain this by listening in on the signals exchanged on the bus, and can block output from the source when the processor gives up control over the bus to the other unit.

A risk potential also exists in systems having a debugger interface, which generally serves to provide an external host computer with insight into the processes performed by the processor unit, its register contents, etc., so that errors in the processor unit's operating program can thereby be detected and eradicated, or so that technical malfunctions of peripherals connected to the microcontroller system can be diagnosed. The fact that the access control unit blocks output from the source when the processor unit is communicating via the debugger interface prevents confidential source data from being polled in uncontrolled fashion via that interface. That blockage also engages in the case of an authorized access via the debugger interface, but this does not present further problems, since it can be assumed in the case of an authorized person that he is already familiar with the confidential data and need not read them first from the source.

To make it more difficult for an unauthorized person to nullify the linkage between communication via the debugger interface and blockage of access to the confidential data, the debugger interface and the access control unit are preferably integrated on one common substrate.

A further possibility for access protection, which is also combinable with those cited above, is that the access control unit encompasses a sensor for sensing a property of the environment of the source, and is set up to block the output of confidential data from the source if the property sensed by the sensor has an impermissible value.

A variety of environmental properties are candidates for sensing by the sensor. The sensor can thus be, in particular, a sensor for distinguishing between the open and the closed state of a housing of the source, a temperature sensor, an operating voltage sensor, or a clock frequency sensor for sensing the working cycle of the microcontroller system. Sensing of an open housing is obviously an indication that an unauthorized person is meddling with the microcontroller system. It is also known, however, that temperatures of the microcontroller system outside a specified operating temperature range can result in individual system malfunctions that unauthorized persons attempt to exploit in order to find out confidential data. Malfunctions that are usable for this purpose can also be induced by applying operating voltages outside a specified range, whether continuously or in the form of short voltage spikes, or by deliberate shortening of individual clock cycles, A temperature sensor, an operating voltage sensor, or a clock frequency sensor can accordingly be used to sense an attack on the system.

When an attack on the system is sensed with the aid of such a sensor, provision can be made for the access monitoring unit to maintain blockage of access until the microcontroller system is switched off or reset. The restarting of the microcontroller system necessary after each detection of an attack greatly reduces the frequency with which the attempted attacks can be made.

The source can easily encompass a memory circuit for the confidential data.

The manipulation security of such a system can be very considerably improved by means for deleting the confidential data in the event the property sensed by the sensor has an impermissible value. If the confidential data have been deleted by this means, the microcontroller system can be put back into operation only if the confidential data are entered again into the source; this requires that they be known, and is not possible for the unauthorized person.

Alternatively, the source can encompass a decoding circuit for decoding encoded data and outputting the decoded data as the confidential data. The encoded data need not be handled in confidential fashion in such a system, i.e. they can be stored in a memory whose contents are not specially protected against exploration. Here again, means for deletion, at least for the data necessary for decoding in the event an attack is sensed, can be provided.

Further features and advantages of the invention are evident from the description below of exemplifying embodiments with reference to the appended Figures.

### BRIEF DESCRIPTION OF THE DRAWINGS

FIG. 1 shows a block diagram of a microprocessor system according to a first embodiment of the invention.

FIG. 2 shows a block diagram of a microprocessor system according to a second embodiment.

FIG. 3 shows a block diagram according to a third embodiment of the invention.

### DETAILED DESCRIPTION

The microcontroller system shown in FIG. 1 encompasses a processor unit 1 that is integrated, together with an erasable permanent memory (referred to hereinafter as internal ROM 2), an access control unit 3, one or more sensors 4, and optionally an erasure signal generator 5, on one common semiconductor substrate 6 symbolized by a rectangle surrounding components 1 through 5. The processor possesses a plurality of registers, not depicted individually in the Figure, for storing intermediate results of a program executed by it; if necessary, a random-access memory (referred to hereinafter as internal RAM 7) for storing intermediate results can additionally be integrated on substrate 6.

Processor unit 1 communicates with internal ROM 2, and if applicable with internal RAM 7, via an internal bus whose address and data lines are together labeled 8 in the Figure. Address and data lines 8 of the internal bus are connectable, via a switch 9 likewise accommodated on substrate 6, to corresponding lines 10 of an external bus. Switch 9 is under the control of access control unit 3.

An external ROM 11, an external RAM 12, a debugger interface 13, and one or more peripheral device interfaces 14 are connected to the external bus. Debugger interface 13 allows an external host (not depicted) to poll the contents of external memories 11, 12 and, via peripheral device interfaces 14, to poll states or sensing results of attached peripheral devices. A debugger interface of this kind is necessary in particular when the microcontroller system is to be used as an engine control unit in a motor vehicle, so that malfunctions of the microcontroller system or of one of the devices controlled by it can be diagnosed with the aid of information polled via debugger interface 13.

In normal operation, access control unit 3 decides, for each read access of processor unit 1, whether the polled address belongs to one of internal memories 2, 7 or to one of external memories 11, 12, and in the former case keeps switch 9 open so that data read out of the internal memories cannot be picked off from the external bus.

Debugger interface 13 is connected to processor unit 1 via a separately drawn control line 15 of the bus, which can have different functions. It can be, for example, an interrupt or reset line that enables debugger interface 13 to trigger an interrupt routine or restart routine of the processor unit in which the latter delivers onto external bus 10 data requested by debugger interface 13, so that debugger interface 13 can forward them. Access control unit 3, which is connected both to control line 15 and to lines 8 of the internal bus, likewise receives the interrupt signal of debugger interface 13 and checks whether the start address of the interrupt routine or start routine, which address shortly thereafter appears on the address lines of the internal bus, belongs to the address region of internal ROM 2. If so, it is assumed that the interrupt routine or restart routine is the one originally provided by the manufacturer of the microcontroller system, since the contents of internal ROM 2, because of its integration on substrate 6 together with processor unit 1, are difficult for an unauthorized person to manipulate. If the start address of the interrupt is not located in the address region of internal ROM 2, access control unit 3 continuously opens access switch 9, so that while a manipulated interrupt routine or restart routine can cause the processor unit to read confidential data out of the internal memories, those data nevertheless cannot be written onto the external bus even by way of a write instruction. Access control unit 3 does not close the switch again until the system is switched off or restarted. In the course of a subsequent restart, a check is once again made as to whether the start address of the restart routine is located in the address region of internal memories 2, 7, and if not, switch 9 is immediately opened again.

Separate control line 15 can also be a line whose state indicates whether processor unit 1 or any other system module, for example debugger interface 13, a coprocessor, or a DMA controller, has control over the bus. By outputting a corresponding signal onto line 15, debugger interface 13 can acquire control over the bus and thus quickly read extensive quantities of data out of external RAM 12 or peripheral device interfaces 14, while processor unit 1 remains in a wait state. Here again, access control unit 3 recognizes when debugger interface 13 or (if they are present) one of the other modules acquires bus command, and then opens switch 9 so that confidential data cannot be polled from the registers of processor unit 1, from internal ROM 2, or (if applicable) from internal RAM 7.

The confidential data of internal ROM 2 can be, for example, a secret key that, together with a decoding algorithm stored in external ROM 11, enables processor unit 1 to decode and execute portions of an operating program that are stored in encoded form in external ROM 11. Intermediate decoding results are stored in internal RAM 7 if the registers of processor unit 1 are not sufficient; internal RAM 7 can also be used to keep the decoded program instructions saved for as long as the microcontroller system is in operation, so that they need to be decoded only once after each system start.

In accordance with a first embodiment, sensor 4 is a light sensor such as, for example, a photodiode, which is mounted on the upper surface of semiconductor 6 under an opaque layer. If an unauthorized person removes that layer in order to gain information about the features on semiconductor substrate 6, light falls onto sensor 4 and access control unit 3 receives a corresponding signal from sensor 4. When this happens, in accordance with a first variant, access control unit 3 outputs onto control line 15 the signal (already mentioned above) that indicates command over the bus by a module other than processor 1, and opens switch 9. Because processor unit 1 is shifted into the wait state by this signal and can no longer access the bus, it can no longer read confidential contents out of internal memories 2, 7, so that those contents also cannot be scanned by the (possibly exposed) internal bus. This state is maintained until the entire microcontroller system is switched off.

In accordance with a second variant, if the (as mentioned, optional) erasure signal generator 5 is present, access control unit 3 activates erasure signal generator 5 upon receipt of the signal from sensor 4 indicating light incidence. Erasure signal generator 5 can be embodied, for example, as a voltage converter that, when activated by access control unit 3, converts an operating voltage applied to semiconductor substrate 6 into a higher voltage that is sufficient for electrical writing or erasure of internal ROM 2, and conveys it to internal ROM 2 in order to erase its contents. An attack by an unauthorized person sensed via sensor 4 thus results in immediate annihilation of the confidential data, thus completely eliminating the danger that those data might be spied on.

Instead of a light sensor, a variety of other sensor types can be used as sensor 4 in order to achieve the same success; multiple sensors 4 of different types can also be used in combination. One possible alternative is, for example, a capacitative sensor that reacts to the presence or absence of a metallized film that covers the features on the semiconductor substrate and shields them electromagnetically from the outside, and that an unauthorized person must remove if he wishes to perform direct measurements on the circuits integrated on semiconductor substrate 6. Also usable is a temperature sensor that indicates whether the temperature of semiconductor substrate 6 lies outside a predefined permitted operating range. If that is the case, this is an indication that an unauthorized person is attempting, by overheating or overcooling, to bring about malfunctions of the microcontroller system, as a result of which confidential data might possibly appear on the bus and be read out. The same purpose can be served by an operating voltage sensor that indicates whether the supply voltage of semiconductor substrate 6 lies outside a predefined permitted operating range, or whether it contains voltage spikes that might impair the functioning of the system. Also a possibility is a clock sensor that compares a clock signal conveyed to from outside substrate 6 with one that it has itself generated internally, and detects, on the basis of abrupt changes in the phase offset between the external and internal clock signals, cycles (so-called glitches) that have been maliciously shortened by an unauthorized person.

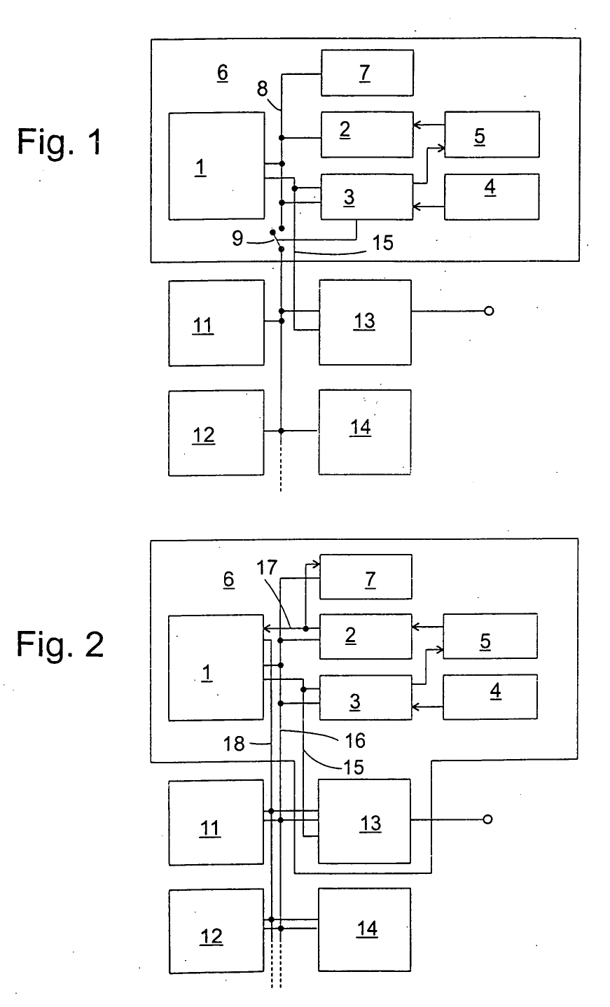

The configuration of FIG. 2 differs from that of FIG. 1 in two aspects. One of them is the construction of the bus system. A single address bus 16 connects the processor unit both to internal memories 2, 7 and to external memories 11, 12, debugger interface 13, and peripheral device interfaces 14. The data bus, on the other hand, is divided into an internal data bus 17 between processor unit 1 and internal memories 2, 7 and an external data bus 18 between processor unit 1 and components 11, 12, 13, 14. As a result of the separation, confidential data cannot travel directly from an internal memory 2 or 7 onto external data bus 18. This enables the processor unit to decode the operating program (stored in encoded form in external ROM 11) with the aid of an algorithm stored in internal ROM 2, store the decoded program in internal RAM 7, and then read the program's instructions via internal data bus 17 and execute them, with no possibility of their being tracked from outside substrate 6.

An indirect output of confidential data from internal memories 2, 7 onto the external bus, by way of an espionage routine that causes processor unit 1 to load confidential data into its registers and then output them onto external data bus 18, is also ruled out here. Because the operating program in external ROM 11 is encoded, an unauthorized person cannot enter such a routine in uncoded form into external ROM 11; he must first discover the decoding algorithm and the key, but is prevented from doing just that by the fact that this confidential information is located in internal memories 2, 7.

One possibility for making processor unit 1 perform such an espionage routine might also involve modifying a table of interrupt and reset addresses that processor unit 1 accesses, and then causing the processing unit, with the aid or an interrupt or reset, to read an interrupt or reset routine directly out of external ROM 11 and execute it. This is prevented, however, according to the present invention (as in the example of FIG. 1), by access control unit 3, by the fact that at each reset or interrupt it reads the start address of the corresponding address from address bus 16 and, via control line 15, deprives processor unit 1 of bus command if the start address is not located in the address region of internal ROM 2. An uncoded routine from external ROM 11 therefore cannot be executed.

A further difference between the microcontroller system of FIG. 1 and that of FIG. 2 is the fact that in the latter, debugger interface 13 is also integrated on semiconductor substrate 6. It is therefore difficult for an unauthorized person to influence communication between debugger interface 13 and the other components integrated on substrate 6.

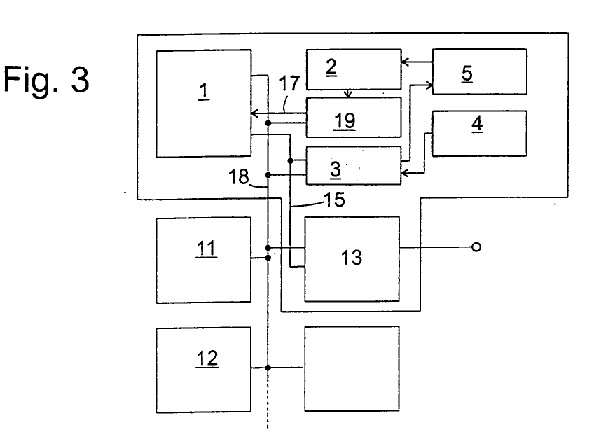

The configuration of FIG. 3 differs from the microcontroller systems described previously in that decoding of the operating program in external ROM 11 is performed not by processor unit 1, but by a cryptographic unit 19 on substrate 6 that is separated in terms of circuitry from processor unit 1. Cryptographic unit 19 contains circuits that are adapted specifically to the encoding algorithm used, and are capable of performing the decoding of the operating program for the processor unit considerably more quickly than could the unit itself, possibly even at the same speed at which processor unit 1 executes the instructions of the operating program. Internal ROM 2 contains the key used by cryptographic unit 19 to decode the operating program. Because it does not need to be read by the processor unit, it is not connected to the microcontroller system's bus and therefore cannot be read either by debugger interface 13 or by processor unit 1.

Internal ROM 2 furthermore contains the boundaries of the address region of external RAM 12 in which the operating program of processor unit 1 is stored in encoded fashion. When processor unit 1 addresses an address in this memory region, and the encoded contents of the relevant memory address appear on external data bus 18, they are received by cryptographic unit 19, decoded, and made available to processor unit 1 via internal data bus 17. Addresses outside the encoded region, for example those in external RAM 12, are addressed and read by processor unit 1 directly via external data bus 18.

After each reset or interrupt signal transferred over a control line of the bus, access control unit 3 connected to the address bus senses the start address of the routine initiated by processor unit 1 as a reaction to the reset or interrupt. If it detects that the address lies outside the encoded region of external ROM 11, i.e. contains data that are evaluated by processor unit 1 without prior decoding and might therefore possibly be specifically modified by an unauthorized person, it deprives processor unit 1 of bus command over control line 15 and thus blocks the system. Cryptographic unit 19 therefore receives no further data to be decoded, and can also output no further decoded data.

What is claimed is:

1. A microcontroller system, comprising:
a substrate;
a processor unit;
a source for confidential data;
a bus that connects the processor unit and the source; and
an access control unit integrated on the substrate together with the source, wherein the access control unit decides, on the basis of a signal transferred on the bus, whether an output of the confidential data from the source is one of permitted and blocked.

2. The microcontroller system as recited in claim 1, wherein:
the access control unit is set up to detect a start address of a routine read by the processor unit,
the access control unit is set up to block the output from the source if the start address lies outside a predefined permissible region.

3. The microcontroller system as recited in claim 2, wherein a definition of the permissible region is stored permanently in the access control unit.

4. The microcontroller system as recited in claim 2, further comprising:
a memory including an address region and being integrated on the substrate with the processor unit, wherein:
the permissible region is contained in the address region.

5. The microcontroller system as recited in claim 1, further comprising:
at least one other unit, wherein:
the processor unit is set up so as to take turns in control over the bus with the at least one other unit, and
the access control unit is set up to block the output from the source when the processor unit gives up control over the bus to the at least one other unit.

6. The microcontroller system as recited in claim 1, further comprising:
a debugger interface, wherein:
the access control unit is set up to block the output from the source when the processor unit communicates via the debugger interface.

7. The microcontroller system as recited in claim 6, wherein the debugger interface and the access control unit are integrated on the substrate.

8. The microcontroller system as recited in claim 1, further comprising:
a sensor associated with the access control unit and for sensing a property of an environment of the source, wherein:
the access control unit is set up to block the output of the confidential data from the source if the property sensed by the sensor has an impermissible value.

9. The microcontroller system as recited in claim 8, wherein:
the sensor distinguishes between an open state and a closed state of one of a housing of the source, a temperature sensor, an operating voltage sensor, and a clock frequency sensor for sensing a working cycle of the microcontroller system.

10. The microcontroller system as recited in claim 1, wherein the access control unit maintains a blockage of the output until the microcontroller system is one of switched off and reset.

11. The microcontroller system as recited in claim 1, wherein the source encompasses a memory circuit for the confidential data.

12. The microcontroller system as recited in claim 8, further comprising:
an arrangement for deleting the confidential data if the property sensed by the sensor has the impermissible value.

13. The microcontroller system as recited in claim 1, wherein the source includes a decoding circuit for decoding encoded data and outputting the decoded data as the confidential data.

14. The microcontroller system as recited in claim 8, further comprising:
an arrangement for deleting data necessary for decoding, in the event the property sensed by the sensor has the impermissible value.

15. The microcontroller system as recited in claim 1, wherein the microcontroller system is a control unit for a motor vehicle.
